(19) United States
(12) Patent Application Publication
(10) Pub. No.: US 2008/0145199 A1
(43) Pub. Date: Jun. 19, 2008

(54) LIFT ASSIST SYSTEM FOR MANUFACTURE OF LINKED FOOD PRODUCTS

(76) Inventor: Richard G. Powers, Overland Park, KS (US)

Correspondence Address: HOVEY WILLIAMS LLP, 10801 Mastin Blvd., Suite 1000, Overland Park, KS, 66210, US

(21) Appl. No.: 11/611,561

(22) Filed: Dec. 15, 2006

(51) Int. Cl. B65G 65/02

(52) U.S. Cl. 414/416.11

(57) ABSTRACT

A lift assist assembly (20, 20a) is provided to facilitate transfer of individual segments (24) of linked food products (e.g., hot dogs) between a first location such as a linker output (40) to a second, spaced location such as a smokehouse delivery rail assembly (30). The assembly (20) includes an elongated rail (52, 228) supporting a depending lift unit (34) and a lower, transverse transfer arm assembly (36). The transfer arm (36) is equipped with selectively extensible and retractable hooks (200) designed to engage and support the segments (24) during transfer thereof; preferably, the hooks (200) are controlled by a pneumatic control circuit (92) so as to automatically retract upon transfer of a food segment at the second, delivery location. The assembly (20) allows the operator to transfer multiple segments (24) without the physical strain associated with manual transfer thereof.

### BACKGROUND OF THE INVENTION

1. Field of the Invention

The present invention is broadly concerned with operator-controlled lift assist assemblies specifically designed to transfer segments of linked food products such as hot dogs from a conventional linker output device to the input rail assembly of a smokehouse. More particularly, the invention is concerned with such assemblies and methods which include a generally horizontally extending arm supported by a lift unit for selective raising and lowering of the arm, and wherein the arm has selectively extensible load-bearing elements for supporting food segments. The arm and lift unit are preferably mounted on an overhead rail allowing translatory shifting movement of the lift unit and arm between the linker and smokehouse input rail assembly. The invention eliminates arduous manual lifting and carrying of food segments.

2. Description of the Prior Art

In the production of linked food products such as hot dogs, conventional linker units receive an incoming meat emulsion, stuff the emulsion into elongated casings, and twist the filled casings at spaced locations in order to created an elongated string of the linked products. The linked product output is continuously draped onto a linker output device such as an endless, moving, vertical or horizontal track. In order to complete production of the linked products, they are generally passed through a smokehouse for cooking. Typical smokehouses have transfer rail systems leading from an input point and through the smokehouse for final cooking of the products.

Normally, the output from the linker cannot be directly placed on the smokehouse rail system. Accordingly, individual segments of the linked product (which may weigh 30 lbs. or more) must be transferred from the linker output to racks mounted on the smokehouse input rail. Heretofore, this transfer of linked food product segments has been a manual labor operation. Such transfers involve passing a hooked rod beneath a segment of the linked product draped over the linker output device, followed by lifting the entire segment by the rod ends. The entire rod/food segment assembly must then be carried to the smokehouse input rail and manually mounted on an empty rail hanger.

When it is considered that such transfers may be made two or three times per minute, it will be appreciated that the labor involved in transferring the product segments is considerable. Indeed, manufacturers have been obliged to hire individuals of large stature and considerable upper body strength in order to perform the transfer operation over an eight hour shift. This practical necessity eliminates most women and many smaller men from this work category.

While various lift assist devices mounted on overhead rails have been proposed in the past and commonly used in many industries, heretofore no specifically designed lift assist assembly has been provided for the transfer of linked food product segments between a linker output device and a smokehouse rail assembly.

### SUMMARY OF THE INVENTION

The present invention overcomes the problems outlined above and provides apparatus for transferring individual segments of linked food product from a first location such as a linker output device to a spaced second location such as a smokehouse input rail assembly. The apparatus preferably comprises an elongated, generally horizontally extending arm assembly having a plurality of load-bearing elements projecting therefrom and operable to support a food product segment. The assembly also has a lift unit operably coupled with the arm assembly for selective raising and lowering thereof, and an elongated rail operably supporting the lift unit and arm assembly and permitting translatory movement of the lift unit and the food segment-loaded arm assembly along a selected path of travel generally between the first and second locations. The load-bearing elements of the arm assembly are operable to engage and support a food segment at the first location. The food segment-loaded arm assembly and lift unit are shiftable along the length of the rail towards the second location in order to permit delivery of the supported food segment to a support component at the second location, and to disengage the elements from the food segment.

In preferred forms, the support rail is pivotal about a first upright axis while the arm assembly is pivotal about a second upright axis separate from the first axis. This allows accurate movement and positioning of the arm assembly for pickup and delivery of the food segments. Also, the arm assembly preferably has a plurality of hooks for engaging and supporting the food segments, with the hooks being selectively extensible and retractable. Control apparatus is provided to extend the hooks and permit loading thereof with a food segment at the first location, and to retract the hooks after delivery of the food segment at the second location. This control apparatus is operable to exert a retraction force upon the hooks while the hooks are under a load supporting the food segment, and to thereby automatically retract the hooks after delivery of the food segment at the second location. Operating buttons for control of the entire transfer apparatus are preferably provided on the arm assembly.

A corresponding method of transferring individual segments of linked food product from a first to a second location also forms an aspect of the invention. The method comprises the steps of providing an elongated, generally horizontally extending arm assembly having a plurality of load-bearing elements projecting therefrom, and moving the arm assembly to a position adjacent the segment, and causing the elements to engage and support the load of the food segment. In the next step, the loaded segment is moved by translation of the arm assembly to a position adjacent the second location, followed by delivery of the food segment at the second location by transferring the food segment to a support component at the second location, and disengaging the elements from the food segment.

### BRIEF DESCRIPTION OF THE DRAWINGS

FIG. 1 is a perspective view of a pair of lift assist systems in accordance with the invention, illustrated adjacent a pair of linker devices and operable to transfer individual segments of linked food products from the linkers to a smokehouse delivery rail apparatus;

FIG. 2 is a fragmentary perspective view illustrating the first step in the use of a lift assist system for transfer of an individual linked food product segment;

FIG. 3 is a perspective view illustrating the operator side of a transverse arm assembly forming a part of a lift assist assembly;

FIG. 3a is a fragmentary perspective view illustrating the operator handle end of the assembly depicted in FIG. 3;

FIG. 4 is a perspective view illustrating the work side of a transverse arm assembly forming a party of a lift assist assembly;

FIG. 4a is a perspective view depicting one of the rod-engaging hook devices of the transverse arm assembly, and illustrating the operation thereof in phantom and full lines, respectively;

FIG. 4b is a vertical sectional view of the hook device illustrated in FIG. 4a;

FIG. 5 is a fragmentary plan view illustrating initial placement of a lift assist assembly of the invention, prior to engaging a segment of linked food products;

FIG. 6 is a side elevational view of a lift assist assembly in the FIG. 5 position thereof;

FIG. 7 is a fragmentary plan view illustrating initial engagement of a lift assist assembly with a segment of linked food product, prior to lifting and removal thereof from the linker output track;

FIG. 8 is a side elevational view of a lift assist assembly in the FIG. 7 position thereof;

FIG. 8a is a side elevational view of a lift assist assembly during engagement of during use of the assembly to remove a segment of linked food product from the linker output track;

FIG. 8b is a side elevational view similar to that of FIG. 8a, but illustrating the lift assist assembly upon full removal of a segment of linked food product from the linker output track;

FIG. 9 is a fragmentary plan view illustrating a lift assist assembly during transfer of a segment of linked food product from the linker output track to the smokehouse delivery rail assembly;

FIG. 10 is a side elevational view of a lift assist assembly in the FIG. 9 position thereof;

FIG. 11 is a fragmentary plan view illustrating a lift assist assembly during the next step of transfer of a segment of linked food product from the linker output track to the smokehouse delivery rail assembly;

FIG. 12 is a side elevational view of a lift assist assembly during initial placement of the supported segment of linked food product onto a hangar forming a part of the smokehouse delivery rail assembly;

FIG. 13 is a fragmentary view illustrating the operation of a lift assist assembly after transfer of a segment of linked food product onto a hangar forming a part of the smokehouse delivery rail assembly, with the operation being illustrated in phantom and full lines respectively;

FIG. 14 is a fragmentary perspective view with parts broken away, illustrating the internal construction of a vertical lift unit forming a part of a lift assist assembly of the invention, and wherein the vertical lift unit is in its fully extended position;

FIG. 15 is a fragmentary vertical sectional view of the primary lift cylinder and related components forming a part of the vertical lift unit as depicted in FIG. 14;

FIG. 15a is a fragmentary view in partial vertical section illustrating the configuration of a vertical lift unit in the fully retracted position thereof;

FIG. 16 is a fragmentary vertical sectional view of the primary lift cylinder and related components forming a part of the vertical lift unit as depicted in FIG. 15a;

FIG. 17 is a perspective view of a pair of lift assist assemblies of the invention, shown supported on floor mounts; and

FIG. 18 is a schematic block diagram depicting the preferred components and connections of the pneumatic control circuit for a lift assist assembly in accordance with the invention.

### DETAILED DESCRIPTION OF THE PREFERRED EMBODIMENTS

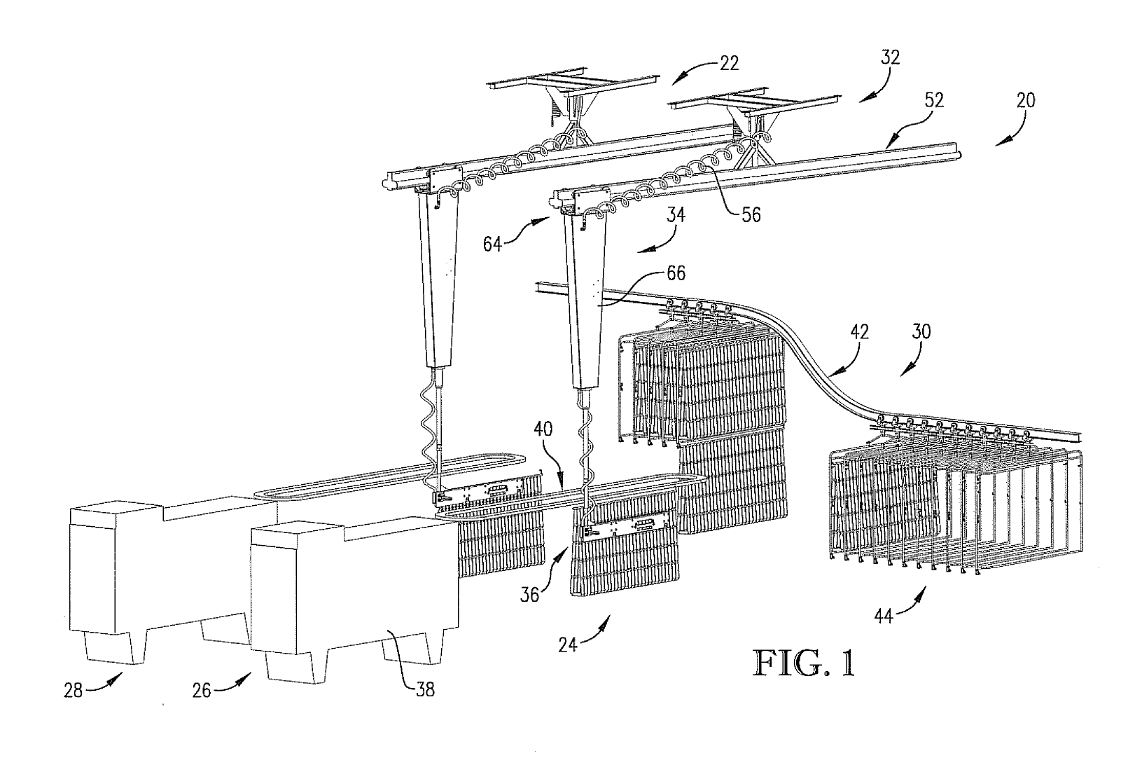

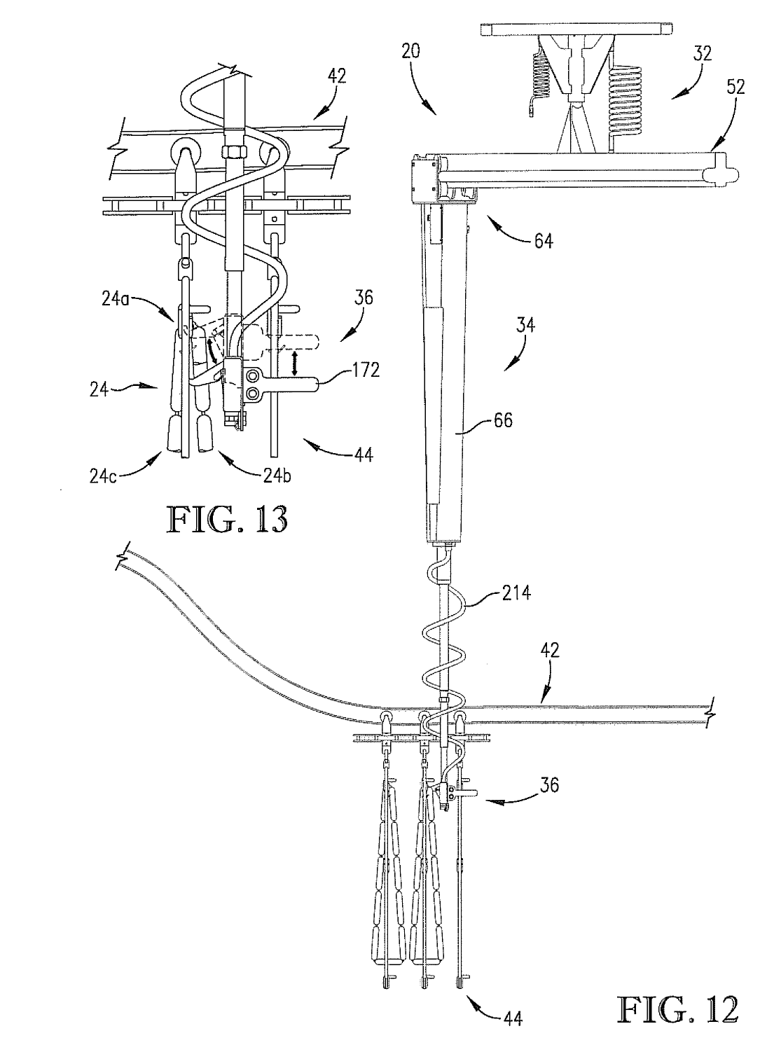

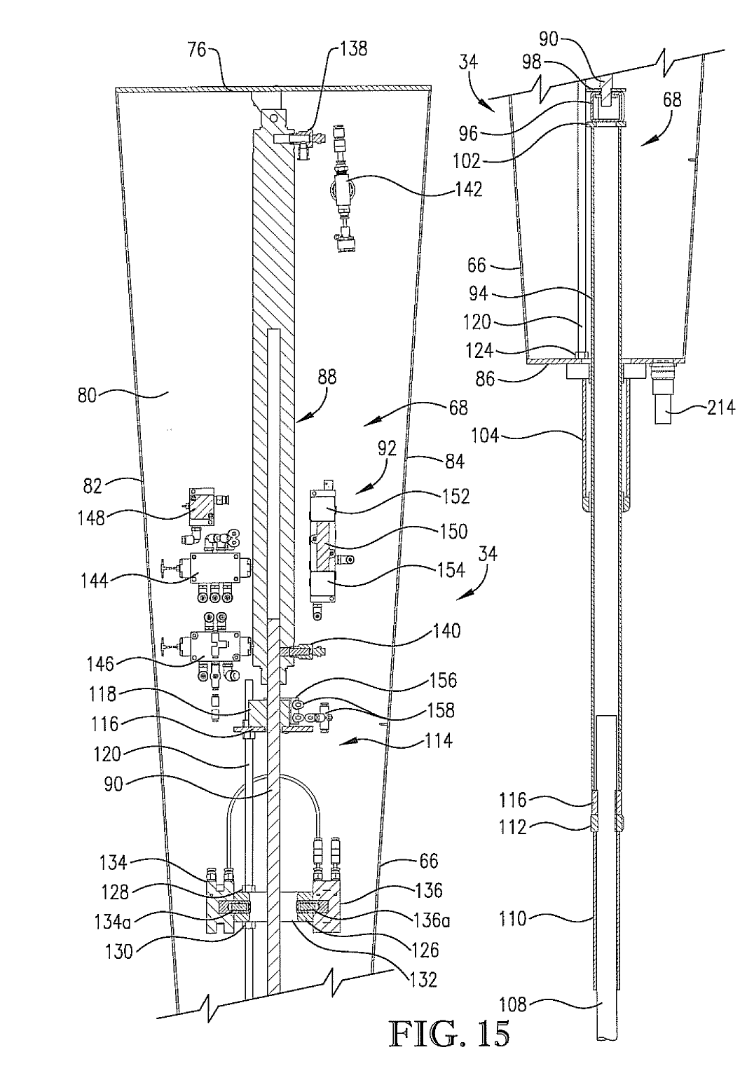

### FIGS. 1-16 and 18

Turning now to the drawings, FIG. 1 illustrates a pair of identical lift assist assemblies 20 and 22 shown in side-by-side relationship and operable for transferring individual segments 24 of linked food product from linkers 26 and 28 to a smokehouse delivery rail assembly 30. Inasmuch as the assemblies 20, 22 and linkers 26, 28 are identical, only assembly 20 and linker 26 will be described in detail.

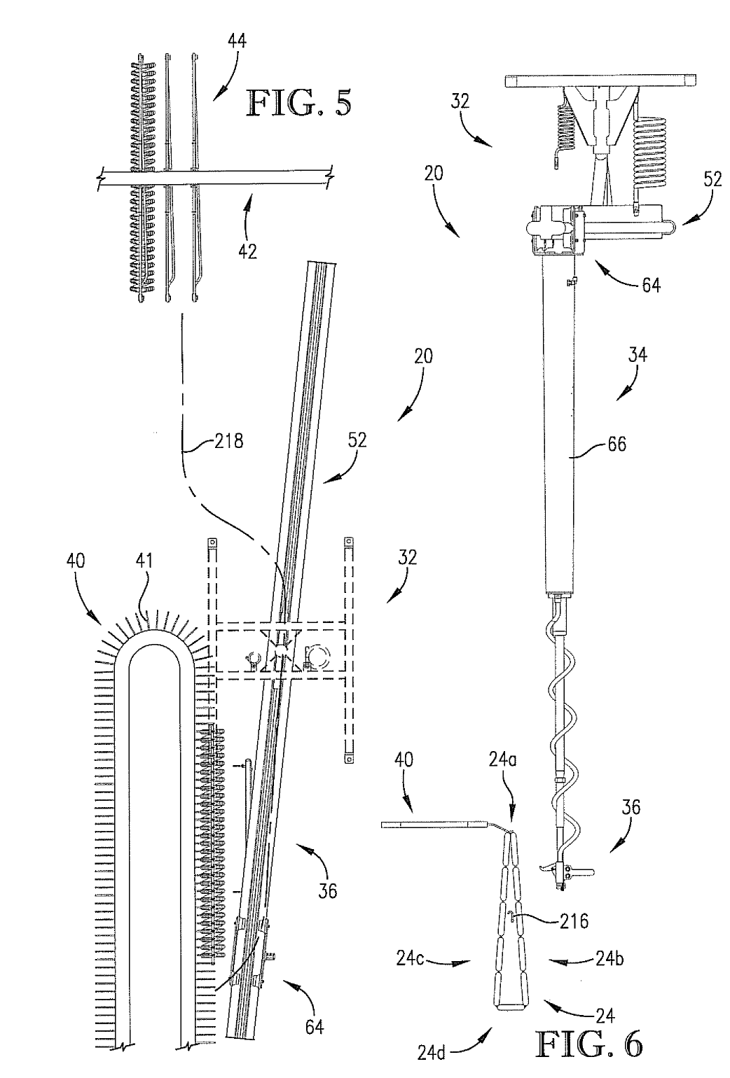

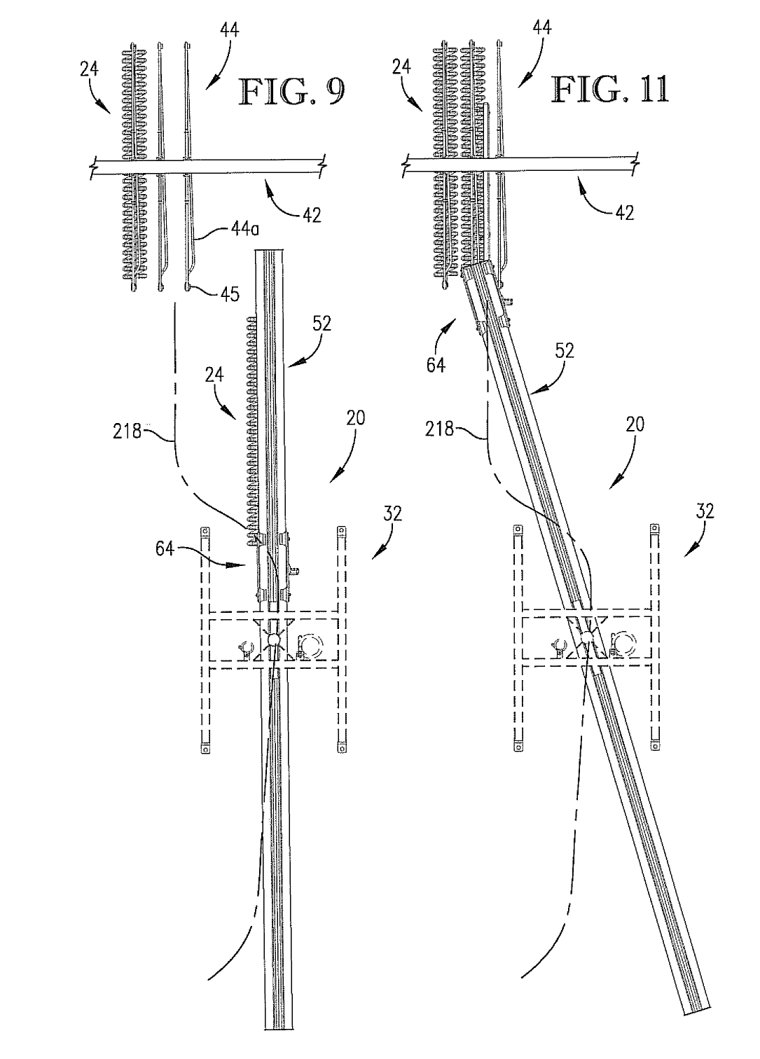

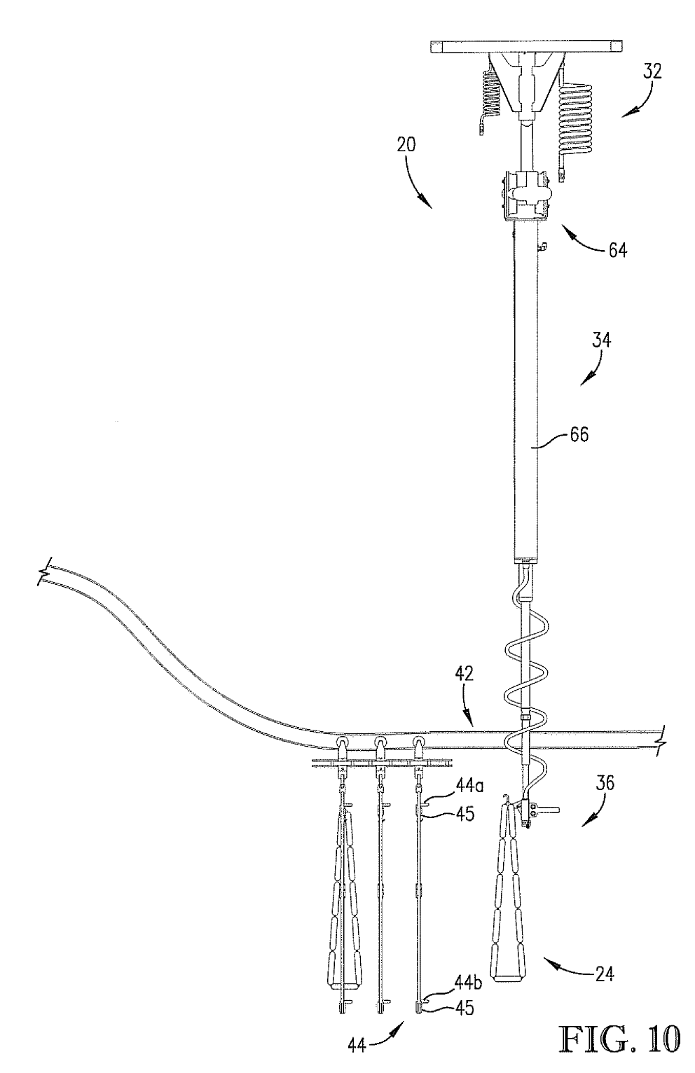

In more detail, the assembly 20 broadly includes a ceiling mounting assembly 32, a vertical lift unit 34 supported by and depending from the rail 52, and a transverse arm assembly 36 supported by vertical lift unit 34. The linker 26 is entirely conventional and includes a linking device 38 operable to create interconnected, linked food products such as hot dogs and to place individual segments 24 thereof onto an endless, oval-shaped track 40 having a series of outwardly extending hooks or tines 41 (FIG. 5). As best seen in FIG. 6, each segment 24 has an apex 24a supported by tines 41, a pair of diverging, downwardly extending sections 24b and 24c, and a bottom section 24d The smokehouse delivery rail assembly 30 broadly has a stationary rail 42 leading to a smokehouse (not shown), together with series of ganged hangars 44 supported and moveable along the length of the rail 42. Each hangar 44 has somewhat S-shaped upper and lower sections 44a and 44b, as well as upper and lower support clips 45 adjacent the front ends thereof (FIGS. 9 and 10).

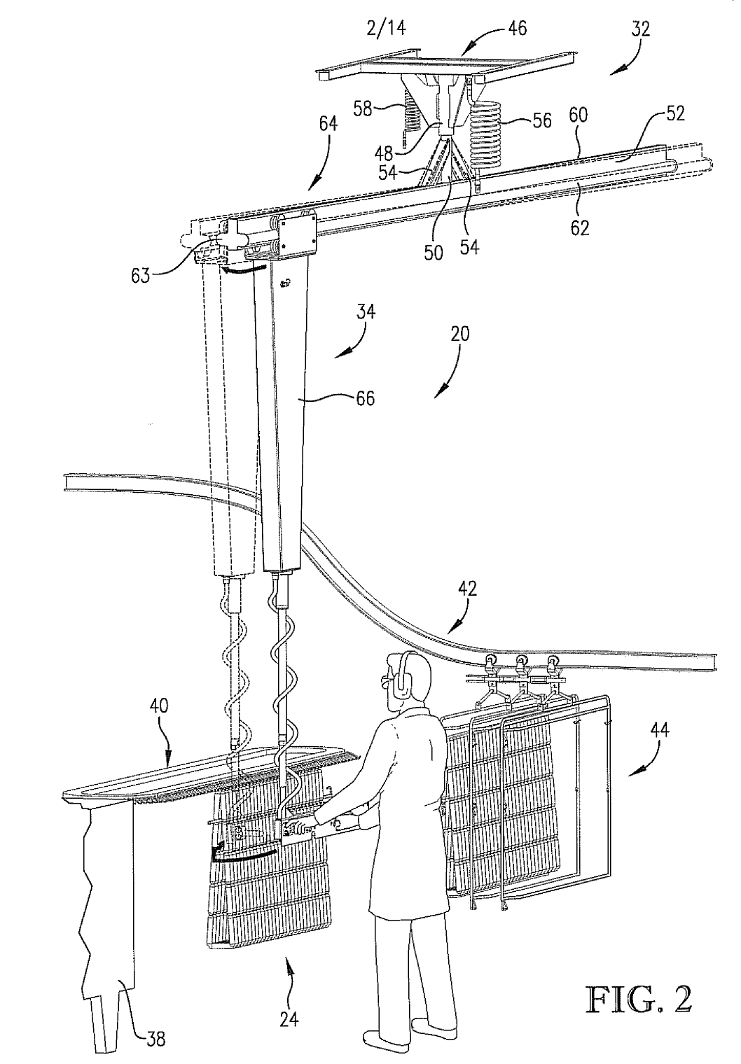

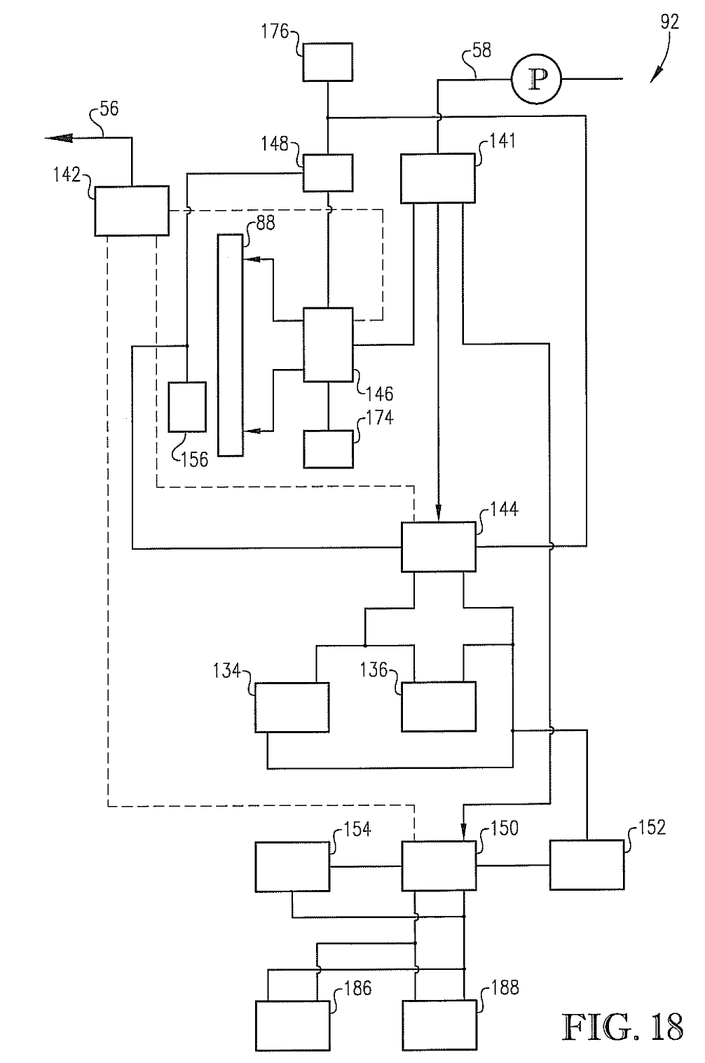

The ceiling mounting assembly 32 is best illustrated in FIG. 2 and includes a fixed bracket 46 designed to be directly secured to an overhead ceiling, with a depending, gusseted mounting tube 48 secured to the underside of the bracket 46. A pivot tube 50 is secured within tube 48 and is directly connected to all elongated rail 52, in order to allow the rail to pivot about an upright axis. A pair of reinforcing struts 54 are secured to the exterior of pivot tube 50 and rail 52 as shown. Coiled compressed air line 58 and exhaust line 56 are also supported on bracket 46, with line 58 connected to a compressed air source P (FIG. 18). The rail 52 includes an upright main body 60 as well as laterally extending roller tubes 62 and 63.

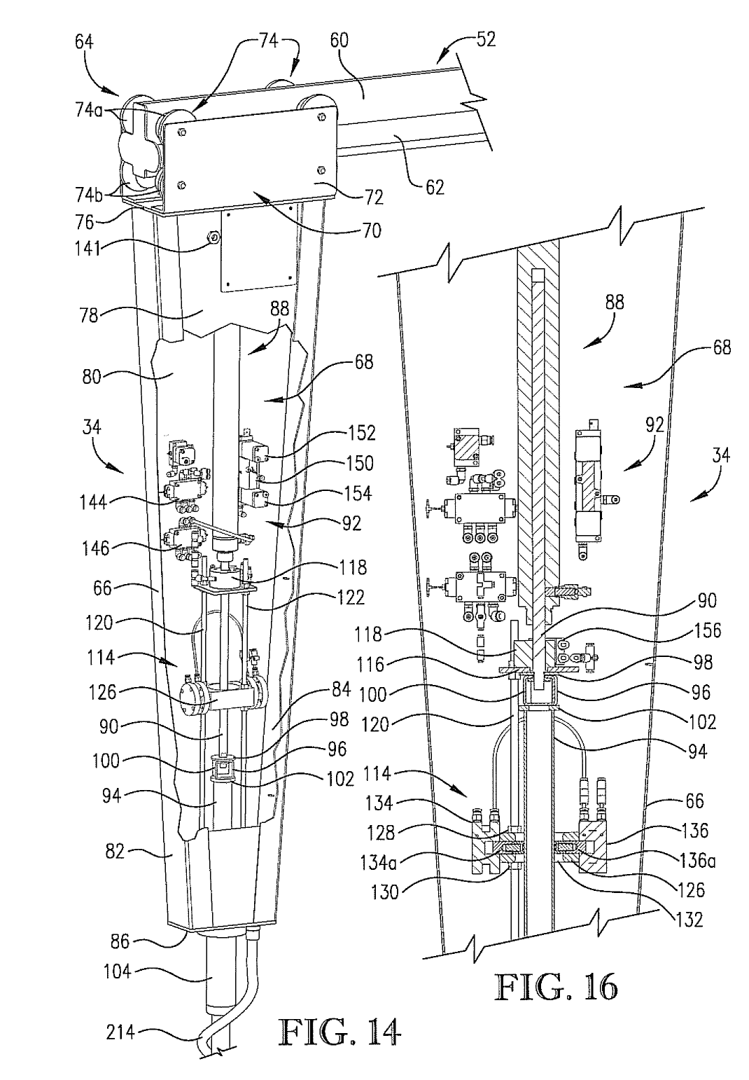

The vertical lift unit 34 includes an upper carriage 64 moveable along the length of the roller tubes 62 and 63, a housing 66 depending from carriage 64, and an internal operating assembly 68 (FIGS. 14-16). Carriage 64 (FIG. 14) presents a generally U-shaped channel 70 defined by upright, spaced apart, L-shaped walls 72 located on opposite sides of rail 52 and supporting two mated pairs of rollers 74, each pair made up of an upper roller 74a and a lower roller 74b. As illustrated, the rollers 74a and 74b are located on opposite sides of main body 60 and move along the lengths of the roller tubes 62 and 63. The housing 66 includes an upper plate 76 secured to the carriage walls 72 as well as interconnected depending front and rear walls 78, 80, and sidewalls 82, 84, and an apertured bottom wall 86. The walls 78-86 cooperatively form a generally trapezoidal housing structure.

Internal operating assembly 68 (FIGS. 14-16) has a primary, double-acting pneumatic lift cylinder 88 with a depending extendable cylinder rod 90, with the cylinder 88 being controlled via a pneumatic control circuit 92 described in detail below. An elongated pipe 94 is secured to the lower end of rod 90 by means of a connection cage 96 and extends through bottom wall 86 of housing 66. The cage 96 has an apertured top wall 98 receiving the lowermost end of rod 90, a pair of upright side walls 100 and a bottom disc 102 secured to the upper end of pipe 94. The up and down reciprocal motion of pipe 94 is guided by a tubular bushing housing 104 secured to the underside of housing wall 86 and having internal bushings (not shown) engaging the outer surface of pipe 94. The lowermost end of pipe 94 is equipped with an internally threaded segment 106 which receives the upper threaded end of a rod 108. A tubular thread cover 110 having an uppermost nut 112 is also threaded onto rod 108, with the nut 112 abutting the underside of segment 106.

The operating assembly 68 further includes a stationary control assembly 114 which is operably coupled with pneumatic control circuit 92 in order to control the operation of primary lift cylinder 88 and transverse arm assembly 36. The assembly 114 (FIGS. 14-16) has an apertured horizontal plate 116 supporting an upright, apertured synthetic resin bushing block 118 and mounted upon a pair of upright, diagonally opposite, all-thread frame rods 120, 122 having the lower ends thereof secured to bottom wall 86 by means of nuts 124. As illustrated, cylinder rod 90 extends through bushing 118 and plate 116. A stop block 126 is also supported on the rods 120, 122 below plate 116 and is adjustably located thereon by means nuts 128, 130. The stop block 126 has a large central through-opening 132 allowing passage of pipe 94 there through. Additionally, it carries a pair of opposite, double-acting pneumatic pancake cylinders 134, 136 each having a rod 134a, 136a which may be selectively extended inwardly into opening 132 adjacent pipe 94.

The pneumatic control circuit 92 is made up of a series of wholly conventional components coupled in a conventional way to achieve the desired and novel control sequences for the operating assembly 68 and transverse arm assembly 36. Accordingly, those skilled in the art will understand that a variety of different hardware components and hookups could be employed, given the desired control sequences. In preferred forms however, the circuit 92 includes upper and lower speed control fittings 138, 140 coupled with cylinder 88. A pair of pneumatic supply and exhaust fittings 141 and 142 are also provided; the supply fitting 141 is operatively coupled with compressed airline 58, and exhaust fitting 142 is coupled with exhaust line 56. The circuit 92 additionally has a pair of air-piloted, four-way, two-position valves 144, 146, logic component 148, and directional control valve 150. The valve 150 is equipped with a pair of timers 152, 154. The bushing block 118 also carries a pair of plunger-operated valves 156 and pneumatic fittings 158.

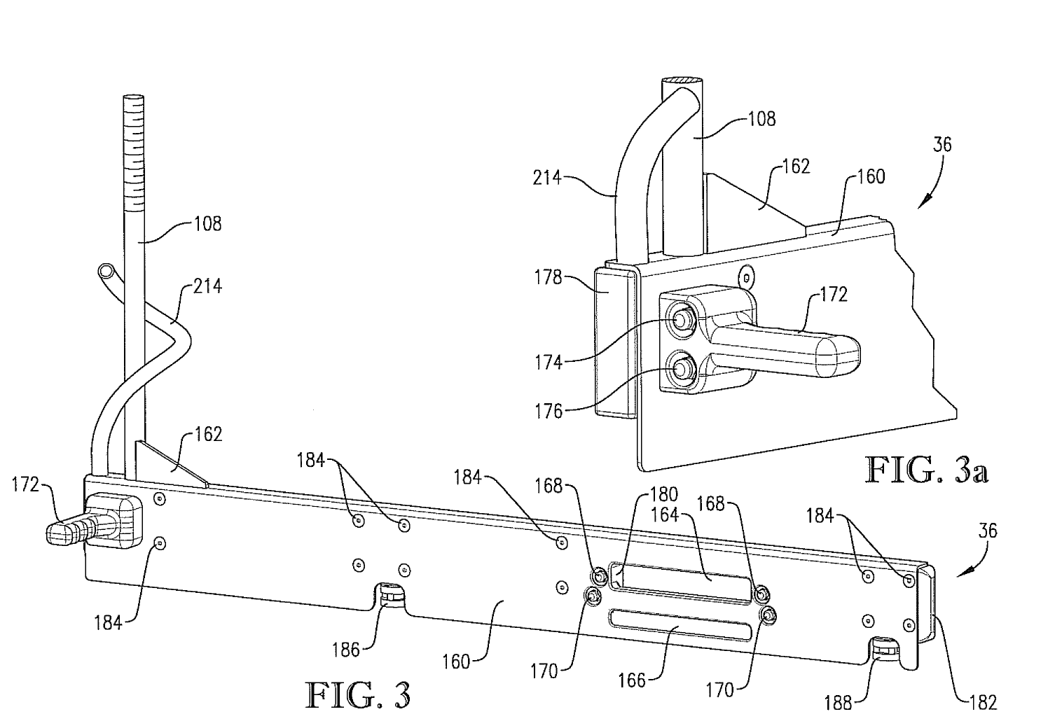

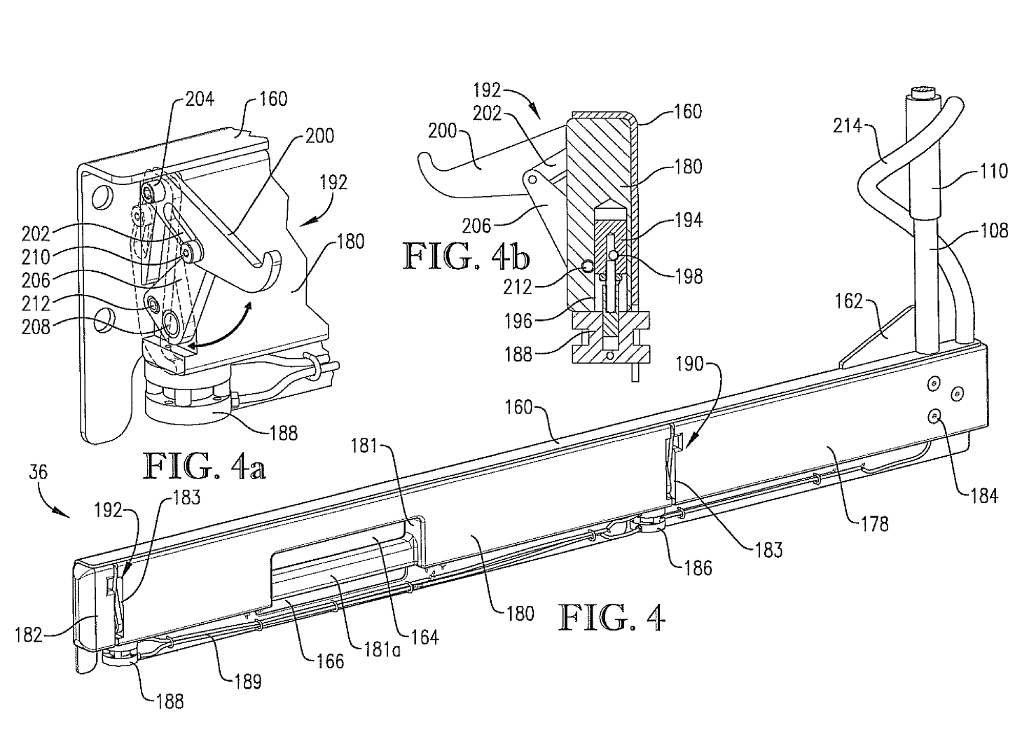

The transverse arm assembly 36 is best depicted in FIGS. 3-4b and broadly includes a generally L-shaped wall 160 secured in a cantilever fashion to the lower end of rod 108 by means of gusset 162 and presenting the operator side of the arm assembly. The wall 160 includes a pair of upper and lower horizontal gripping slots 164, 166, with a pair of operator buttons 168, 170 on each side of the slots 164, 166 for raising and lowering the arm assembly 36 respectively. Additionally, the wall is equipped with an outwardly projecting, end-mounted operating handle 172 also having arm-raising and -lowering operator buttons 174, 176.

The opposite or work side of arm assembly 36 includes three synthetic blocks 178, 180, and 182 secured to wall 160 via threaded fasteners 184 and cooperatively presenting a pair of upright lift hook assembly slots 183. As shown, intermediate block 180 has an elongated slot 181 with a solid horizontal handle piece 181a located between the wall slots 164, 166. A pair of double-acting, pneumatic pancake cylinders 186, 188 are located at the juncture between blocks 178 and 180, and blocks 180 and 182. The cylinders 186 and 188 are coupled with and control a pair of identical lift hook assemblies 190, 192; because these assemblies are identical, only assembly 192 will be described in detail.

Specifically, the air cylinder 188 includes an upwardly extending plunger 194 which is slidable within a vertical bore 196 formed in block 180. A transverse threaded bore 198 extends through the plunger 194 as best seen in FIG. 4b. A lift hook 200 having a motion slot 202 therein is secured to block 180 by means of pivot screw 204. An operating arm 206 is likewise pivotly coupled to block 180 via pivot 208 and has a bushing screw 210 slidable within slot 202. A threaded coupling screw 212 extends through arm 206 and is received within transverse bore 198 of plunger 194. The preferred geometry of the hook 200 and operating arm 206 assure that when the hook 200 is fully extended as illustrated in FIGS. 4a and 4b, the hook is in an over-center position relative to arm 206. Also, when the plunger 194 is retracted the hook 200 and arm 206 are essentially completely contained within the confines of slot 183. The significance of these features will be explained below. Compressed operating air is delivered to arm assembly 36 via coiled air line 214 extending to unit 34 and connected to valve 150.

FIG. 18 illustrates in schematic block form the preferred interconnection of the components of control circuit 92. The connection lines shown in full line operate at positive pressure delivered via fitting 141, whereas the dotted lines represent exhaust lines leading to fitting 142. The logic and control application of circuit 92 will be explained below in the context of operation of lift assembly 20.

### Operation

Returning to FIG. 2, the use of lift assembly 20 for transferring individual segments 24 of linked food products will be described. Initially, the hooks 200 are fully extended, and the vertical lift unit 34 is in its lowermost position illustrated in FIGS. 6, 8 and 15. In the first step, the operator grasps arm assembly 36 using handles 181 and 172, with the hooks 200 in their fully extended position illustrated in FIGS. 4a and 4b. The operator then inserts the hooks through section 24b between the vertical strings of linked food products. This is accomplished simply by moving arm assembly forward so that the hooks 200 extend through section 24b and into the confines of the segment 24. This movement is permitted by virtue of the fact that rail 52 is pivotal about the upright axis defined by tube 50. The operator next grasps a conventional hooked hanger rod 216 (FIG. 6) and inserts the rod along the length of the segment 24 beneath apex 24a, between the sections 24b and 24c, and rests the rod on the hooks 200.

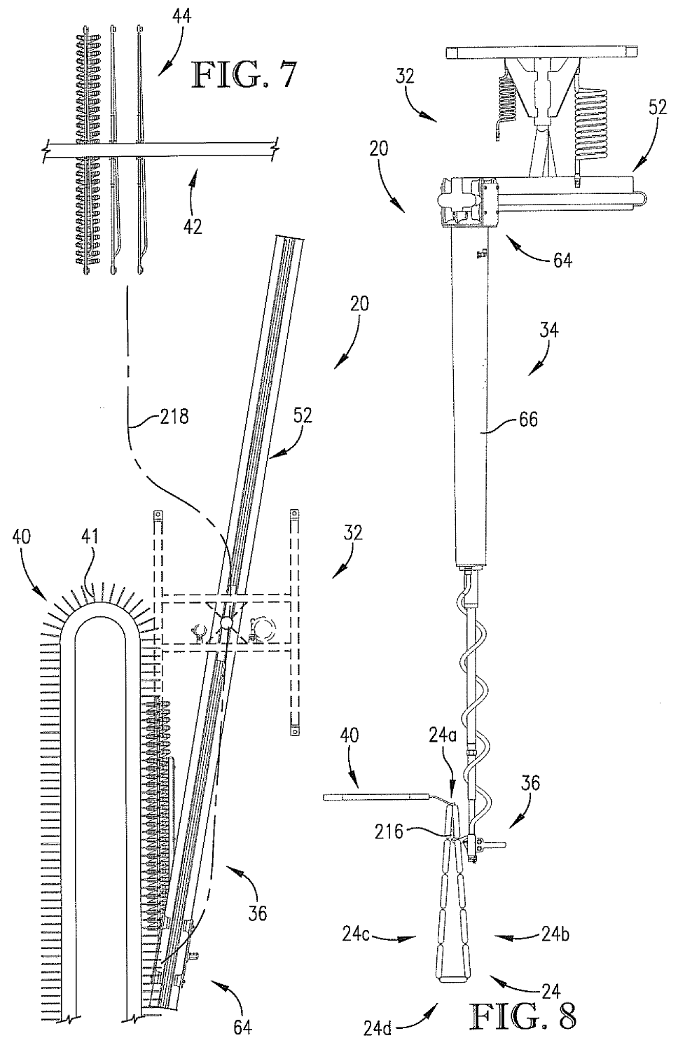

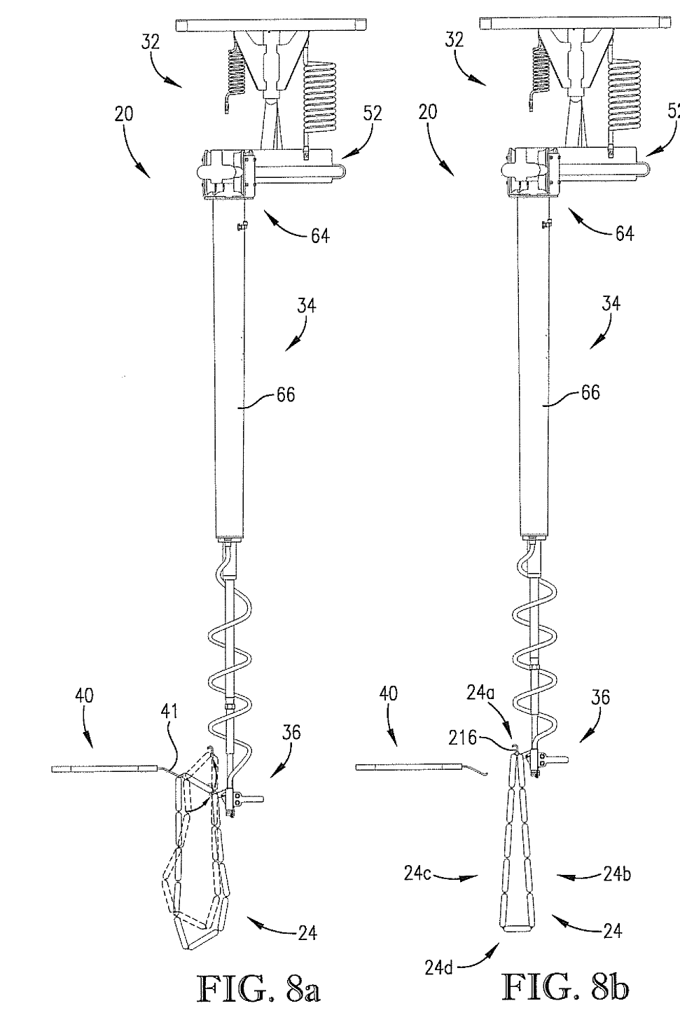

The operator next depresses one of the lift buttons 174 while withdrawing the arm assembly 36. Depression of the button 174 shifts control valve 146, which pressurizes cylinder 88, causing rod 90 to retract. The combined upward and outward motion of the assembly 36 causes the rod 216 to engage the section 24 at the interconnection between highest and next links in the section 24b of segment 24. This is illustrated in FIG. 8a. Such engagement and continued upward movement of the lift unit 34 causes the entire segment 24 to be lifted off of the tines 41 and assume the position illustrated in FIG. 8b, where the apex 24a has been shifted by one link.

Further upward movement of the unit 34 continues until top wall 98 of cage 96 engages the underside of plate 116. This in turn actuates the valves 156, shifting valve 144 and valve 146 (the latter through logic element 148). This has the effect of extending the stop rods 134a and 136a, and also causing the rod 90 to begin to shift downwardly. The rod 90 descends until the plate 102 encounters the extended stop rods 134a, 136a. This positions the rod 216 supporting the segment 24 at the proper height for transfer to one of the hangers 44. The operator then manipulates arm assembly 36 to move the lift unit and arm 36, the latter carrying the rod 216 and segment 24, towards rail assembly 30. Generally, the operator moves these components along an exemplary path of travel 218 illustrated in FIG. 5.

As the operator moves assembly 20 along path 218 an empty rack 44 is approached; this typically involves both pivoting the assembly about the axis of tube 50 and also by translatory movement of the unit 34 and assembly 36. This travel is illustrated in FIGS. 9 and 11.

Once the travel along path 218 is completed, the assembly 36 and supported segment 24 are adjacent the opposite end of rail 52 as shown in FIG. 11, close to an empty hanger 44. The operator then pivots the assembly 36 as necessary to align and position the rod 216 with the empty hanger 44. This can occur owing to the pivotal connection between rod 90 and cage 96. Once aligned, the operator moves the arm 36 along the length of the empty hanger 44, sliding hook 216 and the supported segment 24 along the length of the S-shaped section 44a of hanger 44 until the end of the rod 216 engages the far end of the hanger; at this point the near end of the rod 216 is positioned directly above the upper support clip 45. The operator then depresses the button 176 on handle 172, which shifts valve 144, in turn retracting stop rods 134a, 136a, and allowing further descent of rod 90. In addition, this initiates operation of timer 152 which, when timed out, shifts valve 150. Shifting of valve 150 actuates the cylinders 186 and 188 which in turn exerts a retractive force on the hooks 200; this also initiates operation of timer 154. Initially, however, the hooks 200 do not retract owing to the fact that they still retain the load of the hook 216 and supported food segment 24.

Further downward movement of the assembly 36 causes the near end of the rod 216 to engage clip 45 so that the hanger 44 takes all of the load of the hook 216 and segment 24. At this point the retractive force previously exerted on the hooks 200 comes into play, causing them to fully retract within the slots 183. This permits the operator to easily withdraw the assembly 36 fully through section 24b and from the racks 44 without disturbing or damaging the food segments 24. The operator can then traverse path 218 back to the linker track 40 to reload the assembly 20. During the course of this return travel, the timer 154 times out, operating the cylinder 186, 188 so that the hooks 200 are again extended. This takes the operator back to the starting position to allow a repeat of the forgoing method steps.

In the embodiment of FIGS. 1-16 and 18, the bottoms of the hangers 44 are designed with S-shaped portions 44b and clips 45 to accept a second rod 216 and segment 24. This is best seen in FIGS. 1 and 2, where it will be observed that the rail 42 has an elevated section so that the initially loaded hangers 44 present lower ends at an appropriate height for secondary loading using assembly 20. Of course, single-use racks can also be employed.

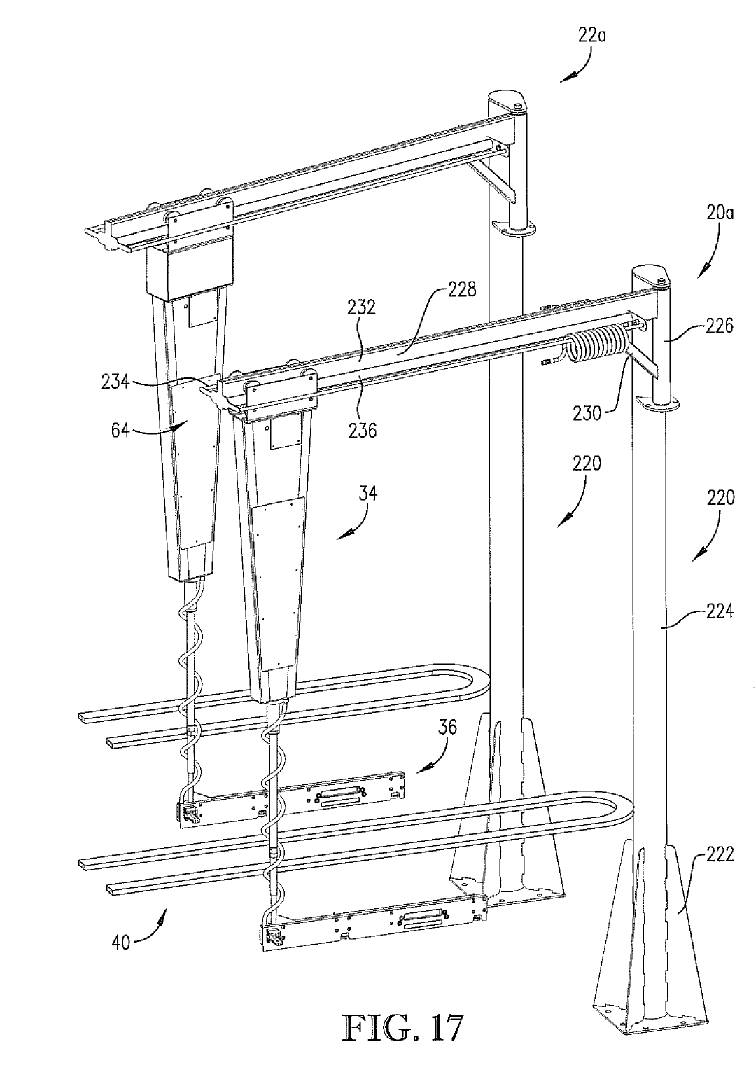

### FIG. 17

FIG. 17 illustrates floor-mounted lift assist assemblies 20a and 22a which are identical to the above-described assemblies 20 and 22 except that, in lieu of the ceiling mounting assemblies 32, floor-mounting assemblies 220 are employed. The assemblies 20a and 22a are identical, and thus only assembly 20a will be described. Furthermore, the assembly 20a has a lift unit 34 and arm assembly 36 which are identical with that of the first embodiment.

The support assembly 220 includes a floor-mounted, gusseted base 222 which supports an upwardly extending, essentially vertical standard 224. A pivot arm 226 is secured to standard 224 adjacent the upper end thereof, with the arm 226 supporting a cantilever rail 228. A strut 230 extends between arm 226 and rail 228 to provide further support. The rail 228 has an elongated main body 232, as well as side flanges 234 and 236. The carriage 64 forming a part of lift unit 34 travels along the length of rail 228 in the manner previously described.

Use of the assembly 20a is essentially identical with that of the corresponding assembly 20, except that pivoting of the rail 228 occurs about the axis of side-mounted pivot arm 226, rather than the axis of tube 50. Moreover, the path of travel traversed by the unit 20 between the loading track 40 and the rail assembly 30 would have a configuration different than that of the exemplary path 218 of the first embodiment.

I claim:

1. Apparatus for transferring individual segments of linked food product from a first location to a spaced second location, comprising:
an elongated, generally horizontally extending arm assembly having a plurality of load-bearing elements projecting therefrom and operable to support said food product segment;
a lift unit operably coupled with said arm assembly for selective raising and lowering of the arm assembly, and
an elongated rail operably supporting said lift unit and arm assembly and permitting translatory movement of the lift unit and the food segment-loaded arm assembly along a selected path of travel generally between said first and second locations,
said load-bearing elements operable to engage and support a food segment at said first location,
said food segment-loaded arm assembly and lift unit being shiftable along the length of said rail towards said second location in order to permit delivery of the supported food segment to a support component at the second location, and to disengage said elements from the food segment.

2. The apparatus of claim 1, said rail being pivotal about a first upright axis.

3. The apparatus of claim 2, said arm assembly being pivot about a second upright axis separate from the first upright axis.

4. The apparatus of claim 1, said arm assembly having a plurality of hooks for engaging and supporting said food segment, said hooks being selectively extensible and retractable.

5. The apparatus of claim 4, including control apparatus operable to extend said hooks and permitting loading thereof with said food segment at said first location, and to retract said hooks after delivery of said food segment at said second location.

6. The apparatus of claim 5, said control apparatus operable to exert a retraction force upon said hooks while the hooks are under a load supporting said food segment, and to automatically retract said hooks after delivery of said food segment at said second location.

7. The apparatus of claim 1, said food segment comprising an elongated, generally horizontally extending support rod, and a series of linked food products supported on the rod.

8. The apparatus of claim 1, said arm assembly having actuating buttons operable to control the up and down movement of said lift unit, and to control the extension and retraction of said elements.

9. The apparatus of claim 8, said arm assembly having a pair of laterally spaced apart handles, there being actuating buttons adjacent both of said handles.

10. The apparatus of claim 1, said elements being selectively extensible and retractable by means of fluid-actuated operators, said operators being incapable of retracting said elements when the elements are extended and loaded while supporting said food segment.

11. The apparatus of claim 10, said operators comprising pneumatic piston and cylinder assemblies.

12. The apparatus of claim 1, said first location comprising a food product linker output, said second location comprising a smokehouse input rail assembly.

13. A method of transferring individual segments of linked food product from a first location to a spaced second location, comprising the steps of:
providing an elongated, generally horizontally extending arm assembly having a plurality of load-bearing elements projecting therefrom;
moving said arm assembly to a position adjacent said segment, and causing said elements to engage and support the load of said food segment;
translating said segment-loaded arm assembly to a position adjacent said second location; and
delivering said food segment at said second location by transferring the food segment to a support component at the second location, and disengaging said elements from the food segment.

14. The method of claim 13, including the step of pivoting said arm assembly about separate, spaced apart first and second upright pivotal axes as necessary during said moving, translating and delivering steps.

15. The method of claim 13, said arm assembly having a plurality of selectively extensible and retractable hooks for engaging and support said food segment, said moving step comprising the steps of extending said hooks, moving said arm assembly so as to position the extended hooks adjacent the food segment, and lifting the arm assembly to effect said engagement and support of said food segment by said hooks.

16. The method of claim 15, including the step of exerting a retraction force upon said hooks adjacent said second location and prior to unloading of the food segment from the hooks, the load of the food segment preventing retraction of the hooks.

17. The method of claim 16, including the step of automatically retracting said hooks upon transfer of the food segment to said component.

18. The method of claim 13, said first location comprising a food product linker output, said second location comprising a smokehouse input rail assembly.

19. The method of claim 18, said support component comprising a hanger shiftable along a smokehouse input rail.
